(19) United States
(12) Patent Application Publication
(10) Pub. No.: US 2005/0005142 A1
(43) Pub. Date: Jan. 6, 2005

(54) Digital rights management

(76) Inventor: Wilhelmus Fransiscus Johannes Fontijn, Eindhoven (NL)

Correspondence Address: U S Philips Corporation;Intellectual Property Department, P O Box 3001, Briarcliff Manor, NY, 10510, US

(21) Appl. No.: 10/495,285

(22) PCT Filed: Oct. 22, 2002
(86) PCT No.: PCT/IB02/04407

(30) Foreign Application Priority Data
Nov. 16, 2001 (EP) 01204388.1

(51) Int. Cl. H04L 9/32

(52) U.S. Cl. 713/193

(57) ABSTRACT

There is disclosed a data carrier (20) having content (22) stored thereon. Access to the content (22) while on the data carrier (20) is controlled by a “copy limited” and “play never” right. This combination of rights allows the carrier (20) to be used, for example, as a jukebox loader. The content cannot be played from the carrier (20), but it can be copied to a jukebox (30) for playing in the jukebox (30). This can be used to provide a dedicated, reusable or throw-away jukebox loader disk that allows a provider to maintain control over the content (22), while allowing the end user sufficient freedom to use the content (22). The data carrier (20) may be embodied in a disk compatible with the CD2 format. A corresponding method of distributing content (22) is also disclosed.

This invention relates to digital rights management. It relates particularly to a data carrier having content stored thereon, and a method of distributing content on a data carrier.

An ever increasing amount of content is distributed in electronic form. Such content most particularly includes audio recordings and audiovisual works. Various types of apparatus are used to reproduce such content. For example, digital jukeboxes have become available to enable a user to access such content without having to use a computer. A typical digital jukebox includes a mass storage device upon which is stored content files that can be rendered at the user's request. At present a common configuration of a digital jukebox includes a hard disk drive on which can be stored many audio tracks, audio reproduction hardware and software for playing these tracks, typically for reproduction through a transducer such as a loudspeaker or a stereo audio headset. In general, a device for reproducing such content will include some form of mass storage device, be it a hard disk or another device on which the content is stored for reproduction.

Several schemes have been adopted for loading apparatus such as a jukebox with content. One such method uses published media such as audio CDs. In that case, the jukebox system contains (or is connected to) a device to access the removable medium, a CD player, for example, and the content is copied to a storage device within the jukebox. Another method involves connecting the jukebox to a computer network, in many cases, the Internet, and downloading the content to the storage device within the jukebox. The latter scheme is sometimes known as electronic music download (EMD).

A problem with content in electronic form arises from the ease with which it can be copied. Content providers are concerned that apparatus such as jukeboxes can allow people to use content without paying for it. With conventional distribution systems, there is no technological reason why content cannot be stored on an effectively limitless number of jukeboxes from a single copy of a CD. Moreover, content can be converted to a digital format, such as MP3 format, and distributed from a website or other suitable server to a limitless number of people over the Internet.

One known countermeasure against the free distribution of content is to include some form of digital rights management (DRM) functionality in the jukebox itself, for example, according to the standards proposed by the Secure Digital Music Initiative (SDMI). Such standards go some way to prevent uncontrolled illegitimate distribution of content that has been released by a content provider.

The rights proposed for such a DRM system associated with published media include several levels of copy restriction: “copy never”, “copy a limited number of times” (e.g. once), “copy the original only”, and “copy unlimited”. Such copying rights are typically provided in combination with a right to reproduce the content.

Some super-distribution systems (that is to say, distribution of content without rights or with limited rights) have been proposed where the original cannot initially be played, and must first be subject to an authorization procedure. In some cases, only a copy and not the original can be authorized for playing, as might be the case where the original resides in a file on a read-only medium. Secure loading of digital jukeboxes with content using EMD has the specific drawback that an Internet connection (preferably broadband) is needed. At present, this adds significant cost to the transfer, and has restricted accessibility.

For the limited number of people that have broadband Internet access, they can typically access it only at their home or place of work.

Most of the proposed rights for DRM systems associated with published media also have specific drawbacks.
“copy never” blocks copying content to a jukebox and, in addition, blocks making backup copies for personal use. This can be seen by users as a violation of the ‘fair use’ principle;
“copy limited” (e.g. copy once) can also be seen as a violation of the “fair use” principle;
“copy original”, offers a provider no protection against users using borrowed or otherwise unauthorized media to load a jukebox; and
“copy unlimited”, offers no protection from free distribution.

“Copy limited” might seem to be the best option to enable jukebox loading without the problem of illegitimate use of borrowed disks. While this may be attractive to the content provider, it may not appeal to users who may feel that they have been denied the option of making (sufficient) copies for personal use.

EP-A-1045386 discloses a system whereby rights to use content are transferred separately from the content itself. This allows a user to copy the content from a data carrier to a reproduction device while the content provider can maintain control over the right to use the content. However, this system requires reproduction device to have the ability to connect to a remote server, which is not always possible, especially for a portable device.

It is an aim of this invention to provide for distribution of content that is secure from the point of view of the provider and allows a user to exercise a satisfactory degree of control over the content.

From a first aspect, the invention provides a data carrier having content stored thereon, in which access to the content while on the data carrier is controlled by a “copy limited” and “play never” right.

A “copy limited” right in combination with a “play never” right for the content on the carrier allows the carrier to be used, for example, as a jukebox loader. The content cannot be played from the carrier, but it can be copied to a jukebox for playing in the jukebox. This can be used to provide a dedicated, reusable or throw-away jukebox loader disk that allows a provider to maintain control over the content, while allowing the end user sufficient freedom to use the content. Of course, a “play never” restriction is not imposed on the content once loaded onto a jukebox. As this arrangement does not provide for rendering the content from the distribution medium, the carrier acts as a transport medium only, and not as a content carrier in the accepted sense.

The “copy limited” right may be a “copy once” right. This is the most restrictive imposition that can be imposed upon a user's access to the content.

Specific measures are required to prevent successful copies being made from the data carrier in excess of those authorized. What must be assured is that once the content has been copied a maximum number of times, the original disk cannot be used again, at least not without further modification of the disk. As a first example, a data carrier embodying the invention may include data that can be amended by a reader for the carrier (that is, data stored in a writeable part of the data carrier). Such data can be amended upon copying the data as a record of the fact that the copy has been made. The data that can be amended may be separate from the content. Separating authorization data from the content can allow a user to make further copies of the content by arranging for the content of the authorization to be reinstated, typically upon further payment to the content provider. Alternatively, part or the whole content itself may be removed from the disk or rendered unusable. Typically, the content may be recorded in a manner such that it cannot be amended by a reader of the data carrier.

Data carriers embodying the invention can, for example, be based upon CD2 technology. In the latter case, authorization to copy the content might be removed by overwriting the content of the keylocker of the disk. As an alternative example, a programmable, reprogrammable or erasable transponder may be embedded in or attached to the data carrier.

In an alternative proposal, authorization to copy the content may be obtained through a network connection, most typically by way of an Internet connection. Authorization in this case need not involve the exchange of money, rights or keys as it does in the case of super-distribution. In embodiments of the invention, some other means to transfer the right to play may be used.

From a second aspect, the invention provides a method of distributing content on a data carrier comprising recording the content on a data carrier and transferring the content to a store of a rendering apparatus, characterized in that the content on the data carrier has a “copy limited” and “play never” right, and which can be assigned a one of “play limited” and a “play unlimited” right.

In embodiments of this aspect of the invention, a change is made to the data carrier in a manner that can subsequently be detected after the content has been copied. In this way it is possible to determine whether the user has the right to make a copy, or if the maximum permitted number of copies has already been made. It is preferable that such a change be made only after verification that the copy has been successfully made in order that the user does not lose rights in the event that a problem is encountered during the copy operation.

Typically, this invention defines a right that combines “copy once” or “copy limited” with “play never” for the original distribution medium and “play unlimited” once the content is loaded on a rendering apparatus. The user pays specifically for the right to load an instance of the content on his or her rendering apparatus; not for the right to relocate, copy and reformat the content for other uses. Such a system can be a much cheaper alternative to EMD and a supplement to published media with play rights.

From a third aspect, the invention provides a jukebox system comprising a storage medium for storing rights data and content, and arranged to transfer content and rights on a data carrier to the storage medium, characterized in that the system is arranged to assign the transferred content one of a “play limited” and a “play unlimited” right in the rights stored on the data carrier, comprise a “copy limited” and a “play never” right.

Further features, aims and advantages of the invention will become apparent upon reading the following description of a preferred embodiment with reference to the accompanying drawings, in which:

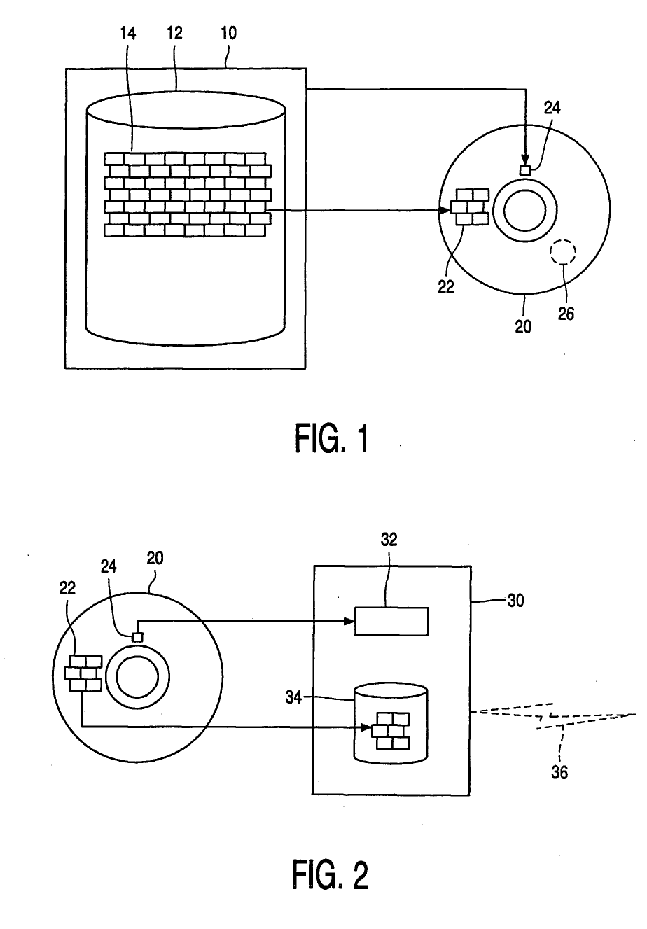

FIG. 1 is a diagram illustrating a system for creating a data carrier embodying the invention; and

FIG. 2 is a diagram illustrating installation of content from a data carrier embodying the invention in the store of a jukebox.

This example makes use of CD2RW recordable and rewritable disks upon which to construct a data carrier embodying the invention. In this example, the content comprises audio recordings, but it is by no means restricted to such content. It is equally applicable to audiovisual, multimedia, software programs and other content.

In this example, a user can buy audio tracks on a data carrier embodying the invention from a retailer, and transfer those tracks to a jukebox 30. The first part of this process is to create the data carrier. This takes place at the retailer's premises, using apparatus as shown in FIG. 1.

The apparatus includes a bulk content store 10 that has a mass storage device 12 on which is stored all of the audio tracks 14 available for purchase. A customer can select the tracks that he wants to buy by means of a suitable user interface. Optionally, the customer will, at the time of selection, be given the opportunity to listen to selected tracks before making a final decision.

Once the selection process has been concluded to the customer's satisfaction, the selected tracks are copied to a blank CD2RW disk 20. A customer will select the tracks that he or she wants to load on his or her jukebox 30 and these are copied to the CD2RW disk, as shown at 22. On the disk 20, the “copy limited” (“copy once”, by default) and “play never” rights are associated with the tracks 22 by storage of appropriate data in the keylocker 24 of the disk 20.

The “play never” right is applied in this embodiment by encrypting the tracks. The decryption key is stored in the keylocker of the disk. The result is a CD2-compliant disk that holds compressed and encrypted CD2 tracks 22 that can be read by a reader, yet which cannot be played by a CD2 audio player. Data can, however, be read from the disk 20 to transfer the tracks to a jukebox system.

To make use of the disk, the customer must have a compliant jukebox 30, as illustrated in FIG. 2.

The jukebox 30 contains storage 32 in which rights data and content can be stored. For example, the storage 32 may include a hard disk, solid state memory, or any other suitable storage presently known or yet to be developed, or a combination of different storage technologies.

The audio tracks 22 on CD2 disk 20 are transferred to a content area 34 of the storage within the jukebox 30 and the “copy never” and “play unlimited” rights are stored in the digital rights area 32 of the storage within the jukebox 30. Now the jukebox 30 can render the content available stored in the content area.

Once the content and rights information has been successfully transferred, the rights contained in the CD2 keylocker 24 are erased. After this operation has been completed, the CD2 disk 20 cannot be reused because the content of the keylocker 24 is no longer available to create the “play unlimited” right. In the event that the user wishes to use the content in a further jukebox, the data within the keylocker 24 can be restored by the retailer upon payment of an appropriate fee. Alternatively, the disk 20 can be thought of as a disposable carrier, and discarded after use.

In an alternative, a count may be stored in the keylocker 24, the counter being decremented upon each copy being made. Once the counter reaches zero, the contents of the keylocker 24 are deleted. In this way, a user can choose to obtain content for distribution to more than one jukebox.

As an alternative or in addition to use of a keylocker 24, a transponder 26 might be embedded or secured to the disk. Data can be written to and read from the transponder 26, for example using radio-frequency signals, which can therefore perform essentially the same function as the keylocker.

As an alternative or additional mechanism for authorizing reproduction of the content, the jukebox may be connected to a remote server over a network link 36, such as the Internet to receive authorization data.

As will be appreciated, the principles described with respect to distribution of content to a jukebox can equally be applied to distribution of digital content to other devices. Moreover, the content is not limited to audio or video content. For example, the invention might be applied to distribution of software to a computer.

1. A data carrier (20) having content (22) stored thereon, in which access to the content (22) while on the data carrier (20) is controlled by a “copy limited” and “play never” right.

2. A data carrier (20) according to claim 1 in which the “copy limited” right is a “copy once” right.

3. A data carrier (20) according to claim 1 in which amendable data stored on it can be amended by a reader (30) of the data carrier (20).

4. A data carrier (20) according to claim 3 in which the amendable data can be amended upon copying of the data as a record of the fact that the copy has been made.

5. A data carrier (20) according to claim 3 in which the amendable data is separate from the content (22).

6. A data carrier (20) according to claim 1 in which the content (22) is recorded in a manner so that it cannot be amended.

7. A data carrier (20) according to claim 1 that is compatible with a CD2 disk reader.

8. A data carrier (20) according to claim 7 in which authorization to copy the content (22) is removed by overwriting the content (22) of a keylocker (24) on the data carrier (20).

9. A data carrier (20) according to claim 1 in which a programmable, reprogrammable or erasable transponder (26) is embedded in or attached to the data carrier (20).

10. A data carrier (20) according to claim 1 in which upon copying of the content (22), part or all of the content (22) itself may be removed from the data carrier (20) or rendered unusable.

11. A data carrier (20) according to claim 1 in which the content (22) cannot be copied until authorization to copy the content (22) is obtained through a network (36).

12. A method of distributing content (22) comprising recording the content (22) on a data carrier (20) and transferring the content (22) to a store (34) of a playback apparatus (30), in which the content (22) on the data carrier (20) has a “copy limited” and “play never” right, and which can be assigned one of a “play limited” and a “play unlimited” right.

13. A method according to claim 12 comprising a step of making a change to the data carrier (20) in a manner that can subsequently be detected after the content (22) has been copied.

14. A method according to claim 13 in which the change is made only after the content (22) has been successfully copied.

15. A jukebox system comprising a storage medium for storing rights data and content, and arranged to transfer content and rights on a data carrier to the storage medium, characterized in that the system is arranged to assign the transferred content one of a “play limited” and a “play unlimited” right in the rights stored on the data carrier, comprise a “copy limited” and a “play never” right.
